(19) United States
(12) Patent Application Publication
(10) Pub. No.: US 2013/0151356 A1
(43) Pub. Date: Jun. 13, 2013

(54) SYSTEMS AND METHODS OF AUTOMATED ECONOMICAL MANAGEMENT OF TABLES AT A RESTAURANT

(71) Applicant: Yat Wai Edwin Kwong, Causeway Bay (HK)

(72) Inventor: Yat Wai Edwin Kwong, Causeway Bay (HK)

(21) Appl. No.: 13/323,662

(22) Filed: Dec. 12, 2011

(51) Int. Cl. G06Q 50/12

(52) U.S. Cl. CPC G06Q 50/12; G06Q 30/0283
USPC 705/15

(57) ABSTRACT

Systems and methods for deciding how a group of restaurant customers should be charged are provided. The system's components include an electronic device that is physically associated with a table, a radio-frequency (“RF”) receiver associated with one or more of a plurality of dishes, a RF receiver associated with a group of customers, a processor, and memory. The electronic device is configured to evaluate whether a group of customers at a table is economical after a certain period of time elapses. The devices determination is based on a comparison of a pre-assigned table cost to a food cost. The table cost may be based on the size of the table, the openness of the table, the view of the table, and the location of the table. The table cost being triggered if the group has not ordered a sufficient amount of food.

### FIELD OF THE INVENTION

This invention is generally related to restaurant expenses. More specifically, this invention is related to economically managing tables in a restaurant so as to maximize profit as a function of time.

### BACKGROUND OF THE INVENTION

In any given restaurant, there are many tables for customers to have dinner or lunch. Some tables are larger in size, which accommodate a larger group of people. Others, meanwhile, are smaller, to accommodate a smaller group. Certain tables also have better views or locations over others, which often are provided to premium customers.

Currently, there are many problems restaurants are facing. Cost control is one of them, as competition is high. More specifically, a restaurant may always want to pay attention to the amount of time a specific group of customers has occupied a table. If the amount of time occupied is short, the restaurant may serve another group of customers with the same table. Thus, making that particular table more profitable. If, however, the time spent occupying the table is long, the table may become less profitable. Such customers often bring in magazines or newspaper with them, and stay in the restaurant for a long time, without ordering much food. If there are too many of such customers, the restaurant may lose financial viability. However, a restaurant may not always desire to ask a customer to leave, even if the customer is not spending much money in ordering food. There is a need, therefore, for restaurants to manage customers who exemplify such behaviors.

On the other hand, there are certain customers that may be deemed as premium customers. These types of customers may order food that is relatively expensive within a short amount of time. Therefore, these customers are valuable customers to the restaurant. Hence, restaurants should not hesitate to retain these customers to stay longer to order more food. The restaurants should not hesitate to give these customers a better table with better views and location.

In view of the foregoing, there is a need for restaurants to utilize a system that can assess the value brought by the customers, based on the customers' behavior, and make decisions in response thereto.

### SUMMARY OF THE INVENTION

According to embodiments of the invention, a system for deciding how a group of customers of a restaurant should be charged is provided. The system's components include an electronic device that is physically associated with a table, a radio-frequency (“RF”) receiver associated with one or more of a plurality of dishes, a RF receiver associated with a group of customers, a processor, and memory.

The electronic device is configured to evaluate whether a group of customers at a table is economical after a certain period of time elapses. The devices determination is based on a table cost. The table cost is based on the size of the table, the openness of the table, and the view of the table. The table cost is triggered and charged to the group of customers when the group of customers has failed to order a certain amount of food within the time period.

The memory comprises instructions that cause the processor to execute a method. The method comprises the following the following steps. The first step involves detecting, using the electronic device, that the group of customers has occupied the table based on the detection of the RF receiver associated with the group of customers. The second step involves detecting that a first set of dishes has been ordered by the group of customers, through the electronic device physically associated with the table and the RF receiver associated with one or more of the dishes. The next step involves determining if a second set of dish has been ordered by the group of customers.

After the time period elapses, the group of customers is evaluated as to whether or not that are economical. The evaluation is based on computation of: 1) the total amount of the food cost incurred, and 2) the average amount of food cost incurred per person. Next, the food cost is compared to the table cost, and it is determined which is higher. Depending on which is higher, an appropriate action is undertaken.

If the table cost is higher than the food cost, the action involves charging the group of the customers with the table cost instead of the food cost. However, this cost may not be charged to the group if the restaurant is not operating at or near full capacity. If the food cost is higher, then the group is allowed to continue to occupy the table and is not charged just yet.

In a further embodiment of the present invention, the method comprises the additional step of detecting whether a third set of dishes has been ordered by the group of customers. In light of this, after a second time period elapses, the group of customers is re-evaluated as to whether they are economical during the second time period. If the group is economical during the second period, the group of customers is charged the food cost upon vacating the table and the restaurant.

In another embodiment of the disclosed invention, a system for economically managing an occupied table at a restaurant using behavioral factors of customers occupying the table is provided. The systems' components include an electronic device with an RF reader physically associated with a table, an RF receiver associated with one or more of a plurality of dishes, and an RF receiver associated with a group of customers. The table has a pre-determined assigned value. The value is based on the size, location, and favorability of the table, and may be set by restaurant owner or manager. The device is configured to detect when a group of customers has occupied the table and when one or more dishes are brought to the table. The detection is based on the RF reader detecting the corresponding RF receivers. The device is further configured to compute a food value and compare it to the table value, and to charge the higher of the two to the group of customers. The food value is calculated based on the number of customers in the group, the number of dishes brought, and amount of time spent occupying the table.

In a further embodiment of the invention, the group of customers is required to pay the bill and vacate the table if the food value is lower than the table value. In a different embodiment, the group of customers is permitted to continue occupying the table if the food value is higher than the table value. In still a further embodiment, the group is required to pay bill and vacate the table if the food value drops below the table value as a function of time.

It is, therefore, an objective of the disclosed invention to provide a system and method for facilitating the economic management of tables in a restaurant.

In accordance with these and other objects which will become apparent hereinafter, the invention will now be described with particular reference to the drawing.

### BRIEF DESCRIPTION OF THE DRAWINGS

FIG. 1 shows a flow diagram of an exemplary overview of table management system according to an embodiment of the present invention.

### DETAILED DESCRIPTION

Referring now to the figure, a flow diagram of an exemplary overview of table management system is shown. The flow diagram shown is a mere example of one of many possible arrangements of the systems and methods of the disclosed invention. In order to better understand the invention, this diagram exhibits a general overview of the way in which the invention is carried out without getting into the technical details, which will be discussed in detail later on in this specification.

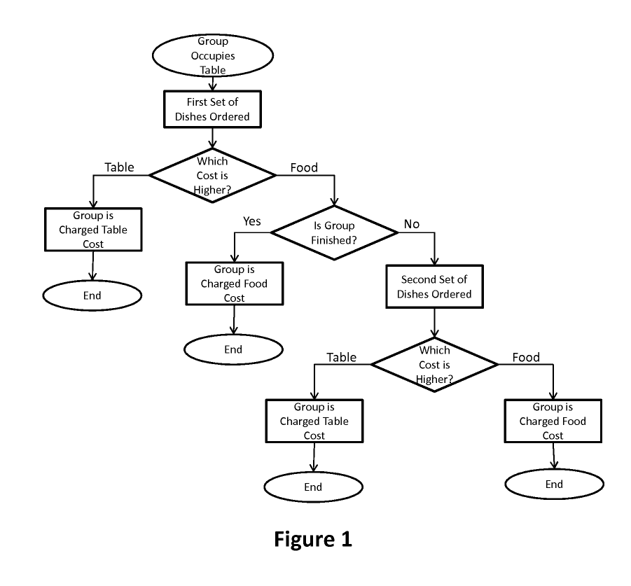

Referring still to FIG. 1, the method begins when a group of customers occupies a table at a restaurant. The particular table that the group is sat down at is important as every table in the restaurant will be assigned a unique ‘table cost’. The table cost is an amount of money which valuates the favorability of that particular table. The table cost may be based on the view of the table, the location of the table, and the size of the table. The table cost may remain fixed, or may change as a function of time (i.e. the table cost gets higher the longer the group occupies the table). As with any group of patrons at a restaurant, the first order is placed and delivered to the table. After the group is given a certain period of time to eat, the system determines whether the pre-assigned table cost or the food cost is higher. The food cost may simply be the cost of the dishes ordered, but it may also incorporate the average cost per person of the food ordered. If the table cost is found to be higher than the food cost, then the group is charged the table cost, and may be given the bill (which implies to the group that it is time to pay the bill and vacate the table). If the food cost is found to be higher, the group is allowed to remain at the table should they choose to stay. If the group is finished eating, then the group is charged the food cost. If the group is not finished, they will have chosen to order for food. A second set of dishes is ordered and delivered. After a second time period elapses, the group is once again evaluated as to whether or not they are ‘profitable’ in the eyes of the restaurant. The total food cost and table cost is compared once again. In this example, it is envisioned that the table cost will increase with the passing of time, thus a higher value will be used in this second evaluation. The food cost is the aggregate total cost of all of the food ordered. Once again, depending on which value is higher, that particular value is charged. In this example, it is assumed that no matter which value is higher, the group will be finished, will pay the bill, and will vacate the table. However, in variations of the present invention, the group may remain at the table for a third time period and so forth.

Obviously, the present invention may not be suitable for all restaurants. For example, in certain embodiments, the table cost may not be triggered if the restaurant is not operating at or near full capacity. The reason for this is because if the restaurant is not busy, and there is no one waiting for tables, then there is no reason to rush customers out for not spending enough money. A good example of the type of restaurant in which the invention may be useful would be a popular coffee shop which offers free internet or WiFi. For example, a customer may arrive in the morning, order a single cup of coffee, and occupy table all day with their laptop without ordering anything else. This system would ensure that the restaurant maximizes its profitability during busy time frames.

Referring now to the technical details of how the system of the present invention works, the system's components include an electronic device that is physically associated with a table, a radio-frequency (“RF”) receiver associated with one or more of a plurality of dishes, a RF receiver associated with a group of customers, a processor, and memory. The RF receiver associated with each of the dishes may be built into the plate, and not visible. It will be able to wireless tell the device the value of the food that is being served on that particular plate. The RF receiver associated with the group of customers may be a small device such as the buzzers given to patrons of a restaurant while they wait for an open table.

Radio frequency identification (“RFID”) tagging is a known method of identification. An information carrying device, or receiver, functions in response to a coded radio frequency (“RF”) signal transmitted from a base station or reader. The RF carrier signal reflects from the receiver and can be demodulated to recover information stored in the receiver. The receiver typically includes a semiconductor chip having RF circuits, logic, and memory, as well as an antenna. Various receiver structures, circuits, and programming protocols are known in the art.

RF systems typically have three components: (1) a tag or receiver (the item being identified), (2) an interrogator or reader, and (3) a data managing medium (typically including cabling, computers, and software which tie together the tags and interrogators into a useful solution). RF products are typically designed to detect receivers when they pass within a predefined range of the reader.

There are generally two types of RF receivers known in the art: passive RF receivers and active RF receivers. Passive RF receivers, unlike active ones, do not require a battery in order to transmit a RF signal frequency.

Instead, passive RF receivers rely on an external source to provoke signal transmission. The RF reader transmits the operating power for these receivers. As a result, such passive RF systems generally have a detection range of limited to a couple meters. However, passive RF receivers may generally be manufactured to be smaller in size than active RF receivers due to the absence of a battery.

Most passive RFID systems work as follows. A reader emits an electromagnetic field for the purpose of powering the receiver. A coil in the receiver is powered by the electromagnetic field, causing the receiver's circuitry to “wake up.” The receiver uses this power to send an identifying signal back to the interrogator.

Referring still to the present invention, the electronic device is configured to evaluate whether a group of customers at a table is economical after a certain period of time elapses. The device's determination is based on a table cost. The table cost is based on the size of the table, the openness of the table, and the view of the table. The table cost is triggered and charged to the group of customers when the group of customers has failed to order a certain amount of food within the time period.

The memory comprises instructions that cause the processor to execute a method. The method comprises the following the following steps. The first step involves detecting, using the electronic device, that the group of customers has occupied the table based on the detection of the RF receiver associated with the group of customers. The second step involves detecting that a first set of dishes has been ordered by the group of customers, through the electronic device physically associated with the table and the RF receiver associated with one or more of the dishes. The next step involves determining if a second set of dish has been ordered by the group of customers.

After the time period elapses, the group of customers is evaluated as to whether or not that are economical. The evaluation is based on computation of: 1) the total amount of the food cost incurred, and 2) the average amount of food cost incurred per person. Next, the food cost is compared to the table cost, and it is determined which is higher. Depending on which is higher, an appropriate action is undertaken.

If the table cost is higher than the food cost, the action involves charging the group of the customers with the table cost instead of the food cost. However, this cost may not be charged to the group if the restaurant is not operating at or near full capacity. If the food cost is higher, then the group is allowed to continue to occupy the table and is not charged just yet.

In a further embodiment of the present invention, the method comprises the additional step of detecting whether a third set of dishes had been ordered by the group of customers. In light of this, after a second time period elapses, the group of customers is re-evaluated as to whether they are economical during the second time period. If the group is economical during the second period, the group of customers is charged the food cost upon vacating the table and the restaurant.

In another embodiment of the disclosed invention, system for economically managing an occupied table at a restaurant using behavioral factors of customers occupying the table is provided. The system components include an electronic device with an RF reader physically associated with a table, an RF receiver associated with one or more of a plurality of dishes, and an RF receiver associated with a group of customers. The table has a pre-determined assigned value. The value is based on the size, location, and favorability of the table, and may be set by restaurant owner or manager. The device is configured to detect when a group of customers has occupied the table and when one or more dishes are brought to the table. The detection is based on the RF reader detecting the corresponding RF receivers. The device is further configured to compute a food value and compare it to the table value, and to charge the higher of the two to the group of customers. The food value is calculated based on the number of customers in the group, the number of dishes brought, and amount of time spent occupying the table.

In a further embodiment of the invention, the group of customers is required to pay the bill and vacate the table if the food value is lower than the table value. In a different embodiment, the group of customers is permitted to continue occupying the table if the food value is higher than the table value. In still a further embodiment, the group is required to pay bill and vacate the table if the food value drops below the table value as a function of time.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A system for deciding how a group of customers of a restaurant should be charged, in light of a set of factors associated with behavior of the group of customers and certain aspects of the restaurant, comprising:
an electronic device physically associated with a table, wherein:
the electronic device evaluates whether a group of customers at the table is economical after a certain amount of time elapses, each table comprises an associated table cost, based on size of the table, openness of the table, and view of the table; and
the table cost is triggered and charged to the group of customers when the group of customers has failed to order a certain amount of food within the time period;
a radio frequency (RF) receiver associated with one or more of a plurality of dishes;
a RF receiver associated with the group of customers;
a processor;
memory storing instructions that cause the processor to execute a method, the method comprising:
detecting, using the electronic device, whether the group of customers has occupied the table, based on detection of the RF receiver associated with the group of customers;
detecting that a first set of dishes has been ordered by the group of customers, through the electronic device physically associated with the table and the RF receiver associated with one or more of the dishes;
detecting that a second set of dishes has been ordered by the group of customers;
after the time period elapses, evaluating if the group of customers is economical, wherein the evaluation comprises a computation of:
a total amount of food cost incurred by the group of customers, including the first set of dishes and the second set of dishes;
an average amount of food cost incurred per person by the group of customers, by factoring in the number of people in the group of customers; and
comparing the food cost and table cost, in light of the average amount of food cost incurred by the group of customers; and
determining whether the food cost or table cost is higher and taking an appropriate action based on said determination.

2. The system of claim 1, wherein if the table cost is higher than the food cost, the appropriate action comprises charging the group of customers with the table cost instead of the food cost.

3. The system of claim 2, wherein the group of customers in is not charged the table cost if the restaurant is operating near full capacity.

4. The system of claim 1, wherein if the food cost is higher than the table cost the appropriate action comprises allowing the group of customers to continue to occupy the table.

5. The system of claim 4, wherein the method further comprises the following steps:
detecting that a third set of dishes has been ordered by the group of customers;
after a second time period elapses, re-evaluating whether the group of customers is economical during the second time period; and
if the group of customers is economical during the second time period, adding to the bill by charging the group of customers with the food cost incurred during the second time period, without charging the table cost.

6. A system for deciding how a group of customers of a restaurant should be charged, in light of a set of factors associated with behavior of the group of customers and certain aspects of the restaurant, comprising:
an electronic device physically associated with a table, wherein:
the electronic device evaluates whether a group of customers at the table is economical after a certain amount of time elapses, wherein each table is associated with a table cost, based on size of the table, openness of the table, and view of the table; and
the table cost is triggered and charged to the group of customers when the group of customers has failed to order a certain amount of food within the time period;
a radio frequency (RF) receiver associated with one or more of a plurality of dishes;
a RF receiver associated with the group of customers;
a processor;
memory storing instructions that cause the processor to execute a method, the method comprising:
detecting, using the electronic device, whether the group of customers has occupied the table, based on detection of the RF receiver associated with the group of customers;
detecting that a first set of dishes has been ordered by the group of customers, through the electronic device physically associated with the table and the RF receiver associated with one or more of the dishes;
detecting that a second set of dishes has been ordered by the group of customers;
after the time period elapses, evaluating if the group of customers is economical, wherein the evaluation comprises a computation of:
a total amount of food cost incurred by the group of customers, including the first set of dishes and the second set of dishes;
an average amount of food cost incurred per person by the group of customers, by factoring in the number of people in the group of customers; and
comparing the food cost and table cost, in light of the average amount of food cost incurred by the group of customers; and
if the group of customers fails to be economical, charging the group of customers with the table cost instead of the food cost, unless the restaurant is operating at full capacity;
detecting that a third set of dishes has been ordered by the group of customers;
after a second time period elapses, re-evaluating whether the group of customers is economical during the second time period;
if the group of customers is economical during the second time period, adding to the bill by charging the group of customers with the food cost incurred during the another time period, without charging the table cost;
detecting that a fourth set of dishes has been ordered by the group of customers;
after a third time period elapses, re-evaluating whether the group of customers is economical during the third time period; and
if the group of customers is economical during the third time period, adding to the bill by charging the group of customers with the table cost, and displaying the charge to the group of customers through the display of the electronic device.

7. A system for economically managing an occupied table at a restaurant using behavioral factors of customers occupying said table, said system comprising:
an electronic device physically associated with a table, said device comprising a radio frequency (RF) reader;
a RF receiver associated with one or more of a plurality of dishes;
a RF receiver associated with a group of customers;
said table having an assigned table value, said table value based on size, location, and favorability;
said device configured to detect when the group of customers has occupied the table and when one or more of said plurality of dishes are brought to said table by detecting said RF receivers using said RF reader;
said device further configured to compute a food value and compare it said table value, and charge the higher value of the two to said group of customers; said food value being based on number of customers in group, number of dishes brought, and amount of time spent occupying table.

8. The system of claim 7, wherein said group of customers is required to pay bill and vacate table if said food value is lower than said table value.

9. The system of claim 7, wherein said group of customers is permitted to continue occupying said table if said food value is higher than said table value.

10. The system of claim 9, wherein said group of customers is required to pay bill and vacate said table if said food value drops below said table value.
